(19) United States
(12) Patent Application Publication
(10) Pub. No.: US 2026/0208231 A1
(43) Pub. Date: Jul. 23, 2026

(54) CLEANING BRUSH

(71) Applicant: Shenzhen Limao E-Commerce Co., Ltd., Shenzhen (CN)

(72) Inventor: Wei Zhang, Shenzhen, Guangdong (CN)

(21) Appl. No.: 19/270,617

(22) Filed: Jul. 16, 2025

Related U.S. Application Data
(63) Continuation-in-part of application No. 29/986,807, filed on Jan. 18, 2025, now Pat. No. D1110738.

(30) Foreign Application Priority Data
Jan. 17, 2025 (CN) 202530031794.7
Jan. 24, 2025 (CN) 202520174088.2

(51) Int. Cl. B08B 1/12; A46B 5/02; A46B 11/00; B08B 1/40

(52) U.S. Cl. CPC B08B 1/12; A46B 5/026; A46B 11/0055; B08B 1/40; A46B 2200/3073

(57) ABSTRACT

A cleaning brush includes a body portion of the cleaning brush and a hook member; the hook member includes a hook body and a latch, wherein the hook body is rigidly connected with the body portion of the cleaning brush, and the hook body defines an opening, the latch is movably connected with the hook body to open or close the opening.

### CROSS REFERENCE TO RELATED APPLICATIONS

The present application is a continuation-in-part application of the U.S. Design Ser. No. 29/986,807 filed on Jan. 18, 2025, which claims the priority of: Chinese Design application No. CN 202530031794.7, filed on Jan. 17, 2025; Chinese patent application No. CN 202520174088.2, filed on Jan. 24, 2025.

### FIELD

The present disclosure relates to the field of cleaning devices, and particularly to a cleaning brush.

### BACKGROUND

Golf clubs are easily contaminated with dirt, grass clippings, and other stains during use, and the cleaning brush can effectively remove these stains to keep the club clean. In order to enable a user to conveniently hang the cleaning brush on a golf bag or clothing, the cleaning brush is typically equipped with a hook member. However, in the related art, the hook member is often connected to the body portion of the cleaning brush through a hanging ring, which tends to wobble during cleaning, leading to collisions between the body portion of the cleaning brush and the hook member. These collisions can generate noise, affecting the user experience.

### SUMMARY

A cleaning brush includes a body portion of the cleaning brush and a hook member; the hook member includes a hook body and a latch, wherein the hook body is rigidly connected with the body portion of the cleaning brush, and the hook body defines an opening, the latch is movably connected with the hook body to open or close the opening.

### BRIEF DESCRIPTION OF THE DRAWINGS

To provide a clearer illustration of the technical solutions in the embodiments of the present disclosure or in the prior art, a brief introduction will be given to the drawings used in the description of the embodiments or the prior art. It is obvious that the drawings described below are merely some embodiments of the present disclosure, and for those skilled in the art, other drawings can be obtained based on these drawings without creative efforts.

FIG. 1 is a schematic view of a cleaning brush according to an embodiment of the present disclosure.

FIG. 2 is another schematic view of a cleaning brush according to an embodiment of the present disclosure.

FIG. 3 is an exploded view of a hook member according to an embodiment of the present disclosure.

FIG. 4 is a schematic view of a body portion of the cleaning brush according to an embodiment of the present disclosure.

FIG. 5 is an enlarged schematic view of portion A shown in FIG. 4;

FIG. 6 is a schematic view of a brush head member according to an embodiment of the present disclosure.

FIG. 7 is a partial schematic view of a brush head member according to an embodiment of the present disclosure.

FIG. 8 is another schematic view of a brush head member according to an embodiment of the present disclosure.

FIG. 9 is a third schematic view of a brush head member according to an embodiment of the present disclosure.

FIG. 10 is a fourth schematic view of a brush head member according to an embodiment of the present disclosure.

FIG. 11 is a cross-sectional view of a pump according to an embodiment of the present disclosure.

FIG. 12 is an exploded view of a cleaning brush according to an embodiment of the present disclosure.

FIG. 13 is a fifth schematic view of a brush head member according to an embodiment of the present disclosure.

FIG. 14 is a schematic view of a protective cover according to an embodiment of the present disclosure.

FIG. 15 is a schematic view illustrating a plug and a one-way air inlet valve according to an embodiment of the present disclosure.

FIG. 16 is a cross-sectional view of the plug and the one-way air inlet valve shown in FIG. 15.

### REFERENCE NUMERALS IN THE DRAWINGS

1, body portion of the cleaning brush; 11, bottle body; 111, first end; 112, second end; 1111, end face; 113, first connecting member; 114, slot; 115, first chamber; 116, anti-slip protrusions; 1131, resilient portion; 1132, flange; 1133, engagement groove; 1134, one-way inlet valve; 12, brush head member; 121, brush head housing; 122, handle portion; 1221, rear surface; 1222, front surface; 1223, flat surface; 1224, concave surface; 123, brush head portion; 1231, inclined surface; 1232, bristles; 1233, outlet port; 124, grip section, 1241, first side surface; 1242, second side surface; 125, connecting section, 126, button, 1251, third end; 1252, fourth end; B, first angle; C, second angle; 2, hook member; 21, hook body; 211, opening; 212, annular portion; 213, protrusion; 214, second connecting member; 215, end portion; 216, main portion; 2131, guide surface; 2121, first open end; 2122, second open end; 2123, rotating shaft; 2124, torsion spring; 22, latch; 221, connecting end; 222, movable end; 13, pump; 130, pump housing; 1301, second chamber; 132, push rod end; 133, inlet end; 134, outlet end; 135, check valve assembly; 1351, resilient member; 1352, barrier member; 136, piston; 127, plug; 1271, connecting channel; 3, protective cover; 31, protrusion; 32, sliding groove; 33, access opening; 128, cord through hole; 129, press part; 1201, third chamber.

### DETAILED DESCRIPTION

In order to make objectives, technical solutions and advantages of the embodiments of the present disclosure clearer, the technical solutions in the embodiments of the present disclosure will be described clearly and completely in the following by referring to the accompanying drawings.

It should be noted that the terms “first,” “second,” and similar terms used in the description, claims, and accompanying drawings are intended to distinguish similar objects and are not necessarily used to describe a specific order or sequence. It should be understood that such data can be interchanged in the appropriate circumstances, so that the embodiments of the present application described here can be implemented in a sequence other than the one illustrated or described here.

In the description of this application, unless otherwise explicitly stated, the terms “mount,” “install,” “connect,” and “communicate” should be broadly understood. For example, they can refer to fixed connections, detachable connections, or integrated connections; mechanical connections; direct or indirect connections through intermediate media; or communication between two components. A person skilled in the art should understand the specific meaning of these terms in the context of this application based on the specific circumstances.

In the description of this application, terms such as “embodiment,” “one embodiment,” and “one implementation” refer to the specific features, structures, materials, or characteristics described in the context of the respective embodiment or implementation, which are included in at least one embodiment or implementation of this application. The illustrative use of these terms in this application does not necessarily refer to the same embodiment or implementation. Furthermore, the specific features, structures, materials, or characteristics described can be combined in any appropriate way in one or more embodiments or implementations.

The following detailed description of the present application will be given in conjunction with the accompanying drawings.

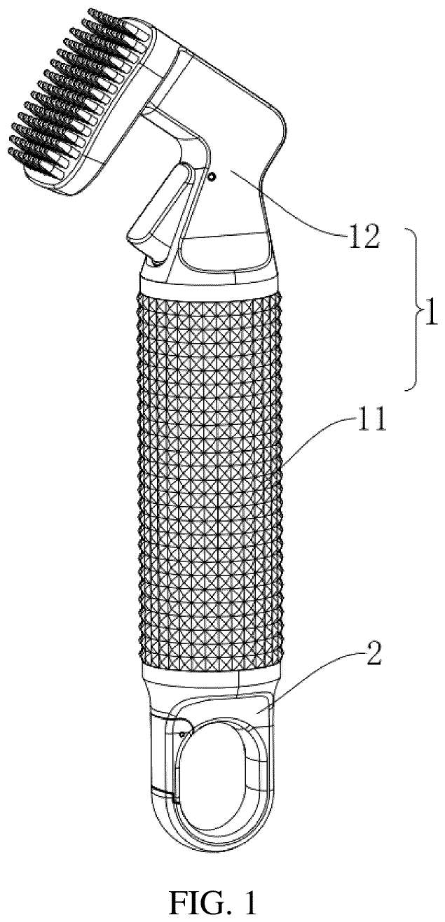

In order to solve the above technical problems, as shown in FIGS. 1 to 3, the present disclosure provides a cleaning brush. The cleaning brush includes a body portion 1 configured to clean golf clubs, such that dirt, grass clippings, and other stains on a surface of the clubs can be effectively removed, thereby keeping the club clean and maintaining its performance. A hook member 2 includes a hook body 21, and the hook body 21 is fixed to the body portion of the cleaning brush 1 via rigid connection. To be specific, the hook body 21 includes an end portion 215 and a main portion 216. When the end portion 215 is connected to the body portion 1 of the cleaning brush, the main portion 216 is prevented from directly contacting the body portion 1. In an embodiment, the end portion 215 and the body portion 1 of the cleaning brush are integrally formed as a one-piece structure. In other embodiments, the end portion 215 and the body portion 1 may be connected by snap-fit connection, adhesive bonding, magnetic attraction, threaded engagement, riveting, ultrasonic welding or other connection manners. When the end portion 215 is connected to the body portion 1, wobbling of the main portion 216 during use is prevented or limited to a slight extent. Therefore, contact between hook body 21 and body portion 1 of the cleaning brush can be avoided. In an embodiment, the end portion 215 and the main portion 216 are integrally formed as a one-piece structure, or the end portion 215 and the main portion 216 are fixedly connected with each other. The hook body 21 defines an opening 211, and the body portion 1 of the cleaning brush can be hung on golf bags or other objects via the opening 211. A latch 22 is movably connected with the hook body 21, enabling the opening 211 of the hook body 21 to be opened or closed flexibly. In this way, stability of the hook member 2 is enhanced, the hook member 2 from colliding with the body portion 1 during use can also be prevented, and the cleaning brush can be prevented from falling off.

In one embodiment of the present disclosure, as shown in FIGS. 1 to 4, the hook body 21 and the body portion 1 of the cleaning brush are configured as an integral and one-piece structure. The integrated design not only enhances mechanical strength of the hook body 21, allowing the hook body 21 to withstand greater tensile or compressive forces, but also effectively eliminates the risk of failure due to loosening or wear of connecting components. In addition, the integrated design reduces the number of parts, simplifies the manufacturing process, and lowers the cost of production.

As shown in FIGS. 1 to 4, in some embodiments the hook body 21 is detachably connected with the body portion of the cleaning brush 1. The hook member 2 is able to be installed or removed by the user as needed, thereby enhancing flexibility and applicability of the cleaning brush. Specifically, detachable connection can be achieved through clamping connection, threaded connection, magnetic connection, or other connection methods. Such that, when the hook member 2 is not in use, the hook member 2 can be removed easily, therefore, the space occupancy of the hook member 2 is prevented. In addition, the hook body 21 allows a quick installation between the body portion of the cleaning brush 1 and the hook member 2, such that the portability and user experience is improved. The detachable connection also facilitates maintenance and replacement of the hook member 2.

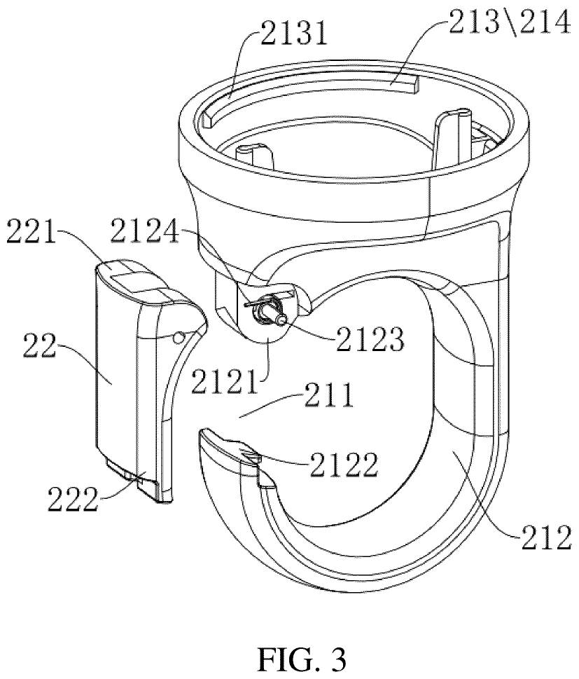

In an embodiment of the present disclosure, as shown in FIG. 3, the hook body 21 includes an annular portion 212, the annular portion 212 has a first open end 2121 and a second open end 2122 spaced apart from the first open end 2121, an opening 211 is formed between the first open end 2121 and the second open end 2122. A rotating shaft 2123 passes through the first open end 2121, and is arranged with a torsion spring 2124. The latch 22 includes a connecting end 221 and a movable end 222, the connecting end 221 is sleeved on the first open end 2121, and the rotating shaft 2123 passes through the connecting end 221, enabling the connecting end 221 to be pivotally connected with the first open end 2121. The torsion spring 2124 is positioned to abut against the connecting end 221, in this way, when the latch 22 is pressed, the torsion spring 2124 is elastically deformed, causing the movable end 222 to separate from the second open end 2122, such that the opening 211 of the hook body 21 is opened, enabling hanging or removal of the cleaning brush. When the pressure is released, the torsion spring 2124 returns to an original state, causing the movable end 222 to re-engage with the second open end 2122, the latch 22 then closes the opening 211 of the hook body 21, preventing the cleaning brush from accidental detachment while suspended. With the latch 22, users can easily mount the cleaning brush on a golf bag or other objects, in this way, wobbling or noise issues due to the instability of the hook member 2 is prevented. In addition, the latch 22 with an openable and closable structure effectively prevents the cleaning brush from being lost during use, further enhancing the practicality and user experience of the cleaning brush.

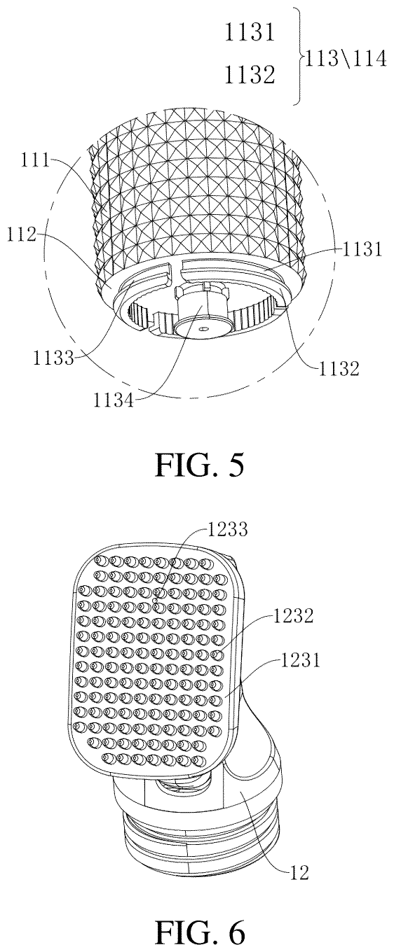

In an embodiment of the present disclosure, as shown in FIGS. 3 to 5, the body portion of the cleaning brush 1 is arranged with a first connecting member 113. The first connecting member 113 is disposed on an end face 1111 of the first end 111 of the bottle body 11, and the first connecting member 113 is configured as a slot 114. In an embodiment, the second connecting member 214 is disposed on an end of the hook body 21 that is away from the annular portion 212, and the second connecting member 214 is configured as a protrusion 213. The slot 114 includes a resilient portion 1131 configured in a sheet-like form and a flange 1132 disposed on the resilient portion 1131, the flange 1132 and the resilient portion 1131 together define an engagement groove 1133, and the protrusion 213 facing the slot 114 is provided with an inclined guide surface, which abuts against the slot 114, enabling the resilient portion 1131 to deform to be engaged within the engagement groove 1133. In summary, the protrusion 213 is capable of being latched within the slot 114, thereby achieving a firm connection between the body portion of the cleaning brush 1 and the hook body 21. The slot 114 and the protrusion 213 are configured to facilitate the assembly between the body portion of the cleaning brush 1 and the hook member 2.

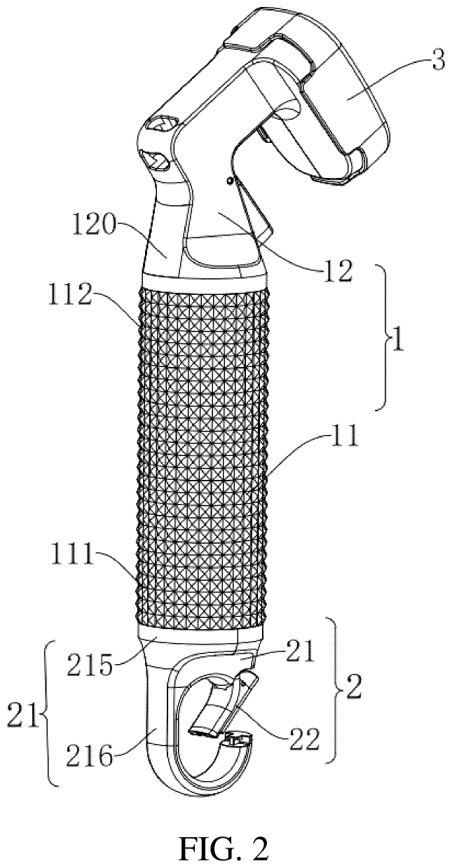

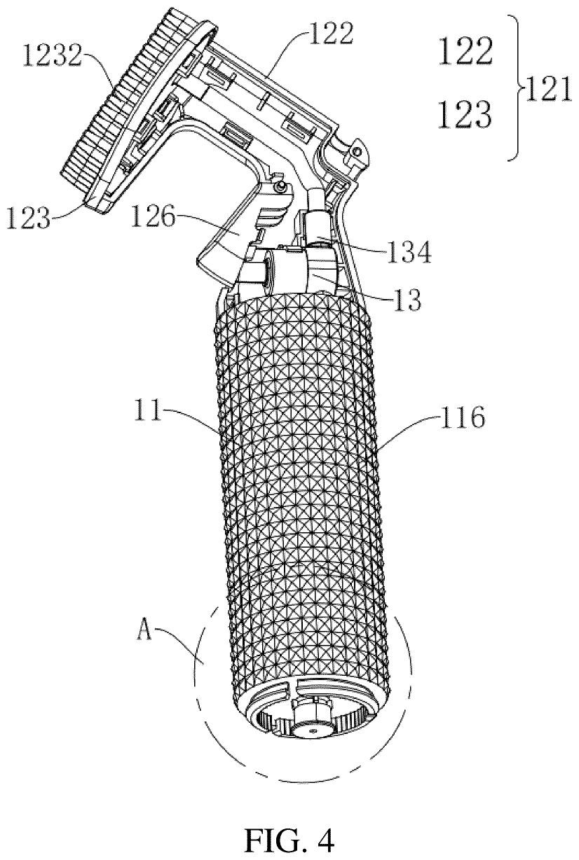

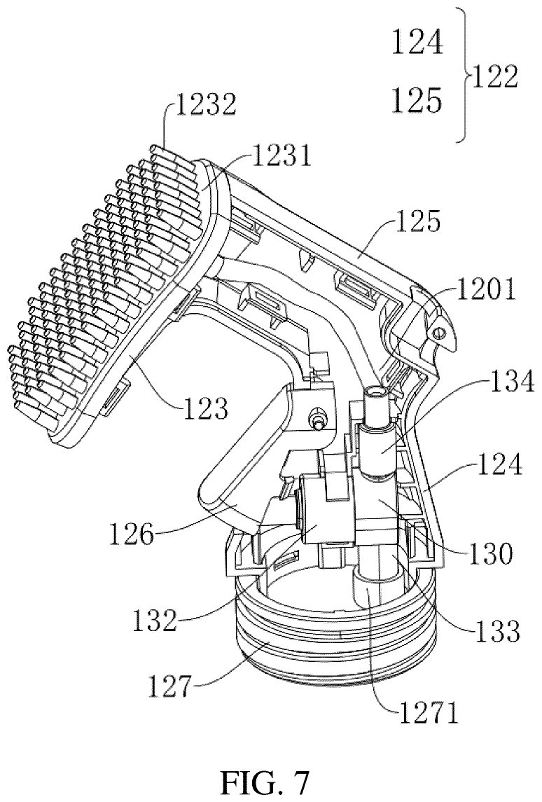

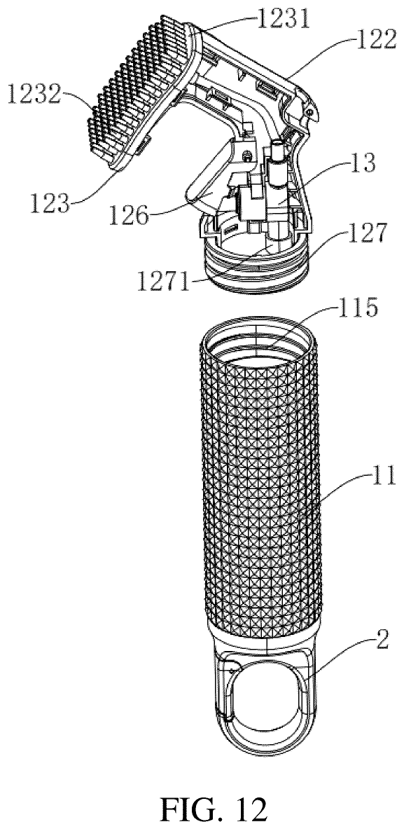

In an embodiment of the present disclosure, as illustrated in FIG. 2, FIG. 4, FIG. 7 and FIG. 12, the body portion of the cleaning brush 1 includes a bottle body 11, a brush head member 12 and a pump 13, the bottle body 11 defines a first chamber 115 configured to store liquid, and the liquid can be either water or detergent. A capacity of the first chamber 115 can be optimized to meet different cleaning requirements. In an embodiment, the bottle body 11 is configured as a cylindrical structure with anti-slip protrusions 116, such that the bottle body 11 can be gripped by the user conveniently. The bottle body 11 has a first end 111 and a second end 112, the first end 111 is connected with the hook body 21, and the second end 112 is connected with the brush head member 12. As shown in FIG. 6, a portion of the brush head member 12 that contacts a target surface includes an outlet port 1233 and bristles 1232. During use, first, the liquid is sprayed through the outlet port 1233 to rinse the target surface, and then the bristles 1232 are used for scrubbing. The outlet port 1233 and the bristles 1232 work together on the target surface, allowing the cleaning brush to remove dirt effectively during use. The pump 13 is arranged inside the bottle body 11 or the brush head member 12, and the pump 13 includes an inlet end 133 and an outlet end 134. The inlet end 133 communicates with the first chamber 115 inside the bottle body 11 through a conduit, which enables an efficient extraction of the stored liquid. The outlet end 134 communicates with the outlet port 1233 on the brush head member 12, ensuring the liquid to be delivered to the brush head member 12 accurately. The liquid can be sprayed through the pump 13, providing necessary moisture and auxiliary function during cleaning.

In an embodiment of the present disclosure, as illustrated in FIG. 2 and FIGS. 7 to 10, the brush head member 12 includes a brush head housing 121, the brush head housing 121 further includes a handle portion 122 and a brush head portion 123, the handle portion 122 and the brush head portion 123 are connected with each other in sequence. The handle portion 122 serves as a part to be held by the user, an end 120 of the handle portion 122 away from the brush head portion 123 is connected with the second end 112 of the bottle body 11, thereby achieving a stable connection between the brush head portion 123 and the bottle body 11, facilitating the user to operate the cleaning brush stably during cleaning. The brush head portion 123 serves as a part of the cleaning brush that directly contacts an object to be cleaned, and includes an inclined surface 1231. In an embodiment, an acute angle is formed between the inclined surface 1231 and a longitudinal direction of the bottle body 11. During use, the surface of the golf club to be cleaned is inclined, and the inclination of the inclined surface 1231 matches that of the target surface, enabling the bristles 1232 to match the target surface, thereby enhancing the cleaning performance of the cleaning brush. Furthermore, the inclined surface 1231 is configured to increase a contact area between the bristles 1232 and the target surface, thereby resulting in an even distribution of pressure, therefore, the areas that are difficult to be cleaned is reduced, ensuring every corner can be cleaned. The outlet port 1233 is also defined on the inclined surface 1231. When the liquid is sprayed from the outlet port 1233, the liquid directly falls onto the target surface. After the liquid rinses the target surface, the user can proceed to scrubbing the surface without changing a holding angle. In an embodiment, the outlet port 1233 is positioned on an upper half of the inclined surface 1231 and is provided as a single hole, this arrangement facilitates the concentration of water pressure for efficient spraying and rinsing. In this way, the cleaning brush is able to perform cleaning operations more efficiently and conveniently.

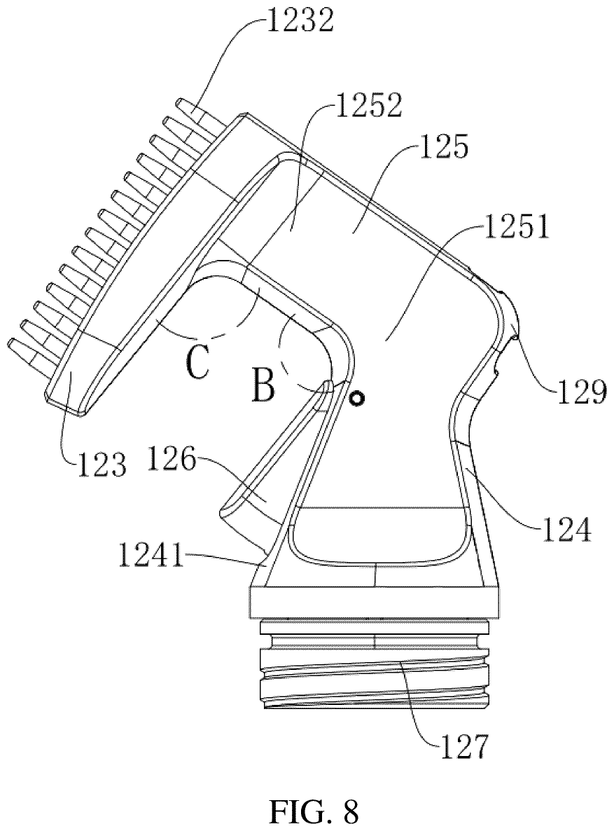

In an embodiment of the present disclosure, as shown in FIG. 8, the handle portion 122 includes a grip section 124 and a connecting section 125, the grip section 124 and the connecting section 125 connects with each other in sequence. The grip section 124 substantially extends along the longitudinal direction of the bottle body 11. The connecting section 125 includes a third end 1251 and a fourth end 1252, a first angle B is formed between the third end 1251 and the grip section 124. In an embodiment, the first angle B is a right angle or an obtuse angle. A second angle C is formed between the fourth end 1252 and the brush head portion 123. In an embodiment, the second angle C is a right angle or an obtuse angle, thereby enabling the inclined surface 1231 to be positioned at an angle. In this way, the grip section 124, the connecting section 125, and the brush head portion 123 together form an approximate U-shaped structure. The first angle B allows the connecting section 125 to transition from the grip section 124 naturally, forming a press part 129 at a joint between the connecting section 125 and the grip section 124. The press part 129 serves as an additional support point during use, ensuring a stable grip. The handle portion 122 is arranged with a button 126 which is connected with the pump 13 to control liquid ejection. The button 126 is positioned on a side of the grip section 124 opposite to the press angle 129, the press angle 129 and the button 126 are configured in accordance with an ergonomic principle, which fully considers the user's habits while operating, facilitating ease of use.

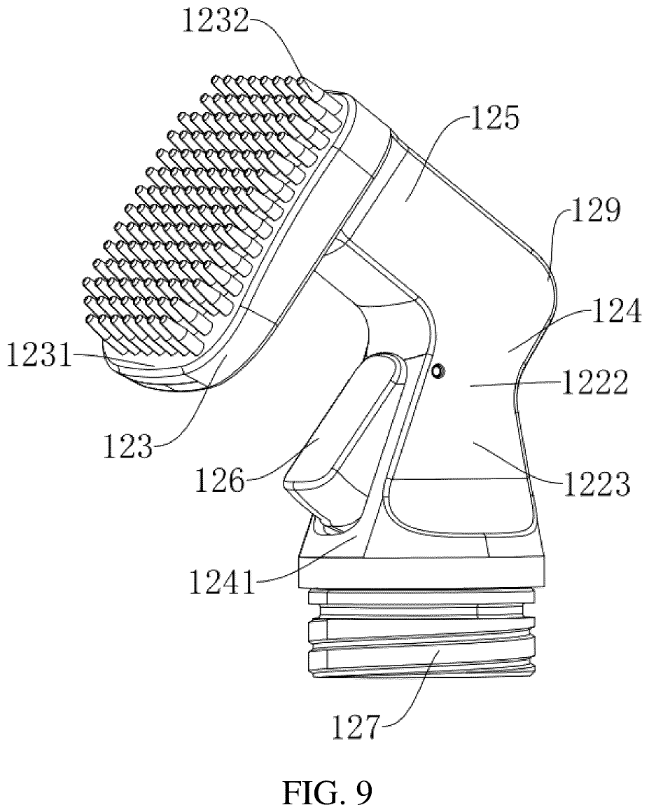

In an embodiment of the present disclosure, as shown in FIG. 9, the grip section 124 includes a first side surface 1241. In some embodiments, the grip section 124 is configured to taper from bottom to top, such that the first side surface 1241 is inclined towards the press part 129, enabling the remaining fingers (such as the index or middle finger) to rest on the first side surface 1241, reducing the stretching and bending of the fingers, thereby decreasing fatigue during operation. The button 126 is disposed on the first side surface 1241, and is also inclined towards the press part 129, such that the user can press the button 126 easily without adjusting the grip posture during use. When the user's thumb presses the press part 129, the index or middle finger can rest on the button 126, enabling controlling of the cleaning liquid ejection. In this way, it not only improves the portability of the cleaning operation, but also reduces cleaning interruptions that may be caused by frequent grip adjustments.

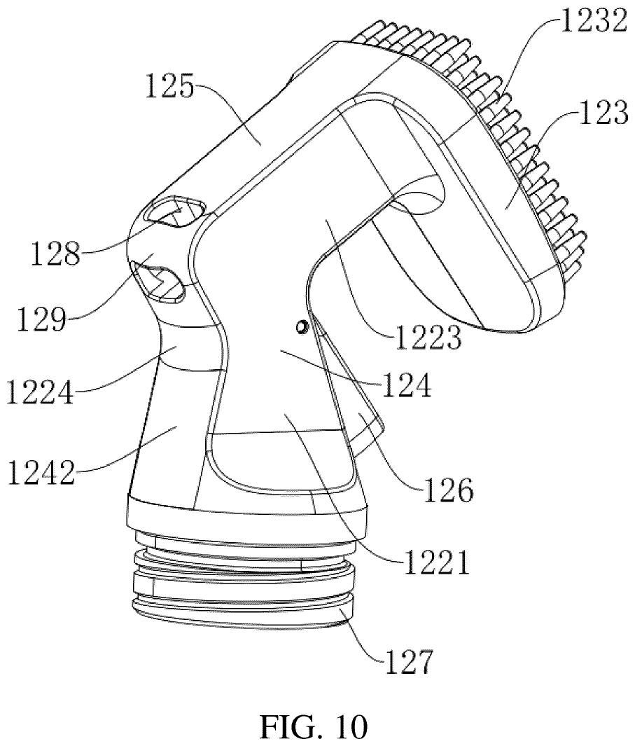

In an embodiment of the present disclosure, as shown in FIG. 10, the handle portion 122 has a rear surface 1221, at least a portion of the rear surface 1221 is truncated inwardly to form a flat surface 1223. That is, the at least a portion of the rear surface 1221 is cut inwardly along a flat plane. The flat surface 1223 is positioned between the first side surface 1241 and the second side surface 1242 of the grip section 124, enabling a gradual transition from a flat surface to a curved surface, thereby maintaining a smoothness shape of the handle portion 122. In addition, the flat surface 1223 enhances a sense of layering and stability of the handle portion 122. The flat surface 1223 can provide an additional support point for user's fingers. When in use, a part of the palm of the user can rest against the flat surface 1223, which is helpful to enhance stability of grip and reduce fatigue.

In another embodiment of the present disclosure, as shown in FIG. 9 and FIG. 10, the handle portion 122 has a front surface 1222 and a rear surface 1221, at least a portion of the front surface 1222 and a portion of the rear surface 1221 are both truncated inwardly to form flat surfaces 1223. When gripping the handle portion 122, a grip posture is not limited to pressing the thumb against the press part 129. The user can place their thumb against the flat surface 1223 of the front surface 1222, allowing the thumb to be positioned alongside the finger pressing the button 126. The front surface 1222 is also provided with a flat surface 1223, enabling the grip section 124 to accommodate various grip postures. Depending on different cleaning requirements and personal habits, the user can place their thumb on either the press part 129 or the flat surface 1223, and the flat surface 1223 may serve as a resting point for the fingers.

In an embodiment of the present disclosure, as shown in FIG. 10, a concave surface 1224 is formed at the joint between the second side surface 1242 and the press part 129. Depending on different cleaning requirements and personal habits, the user can place their fingers on or near the concave surface 1224. When the user's thumb presses on the press part 129, the rest fingers, such as the index finger or the middle finger, may easily and selectively press the button 126, thereby controlling the ejection of liquid. After the liquid is ejected, the user can maintain a same grip posture to brush and clean the target surface. In other words, the entire cleaning process can be performed with one hand, and the grip posture may not be frequently adjusted.

In an embodiment of the present disclosure, as shown in FIG. 7 and FIG. 10, the pump 13 is a T-shaped pump. The pump 13 includes a pump housing 130, the pump housing 130 defines a second chamber 1301, and the second chamber 1301 is configured to be a primary space where liquid and gas circulate inside the pump 13. The pump housing 130 includes a push rod end 132, an inlet end 133 and an outlet end 134, and all of the push rod end 132, the inlet end 133 and the outlet end 134 communicate with the second chamber 1301 inside the pump housing 130. The inlet end 133 and outlet end 134 are arranged in a vertical position relative to each other, and the push rod end 132 is arranged in a T-shaped structure with the inlet end 133 and outlet end 134. A conduit is inserted inside the bottle body 11, extending from the bottle opening to the bottom of the bottle, facilitating the extraction of liquid. The inlet end 133 communicates with the conduit inside the bottle body 11, and the brush head member 12 is also provided with a conduit, the outlet end 134 communicates with the outlet port 1233 through the conduit inside the brush head member 12. In some embodiments, a check valve assembly 135 is received in each of the inlet end 133 and the outlet end 134. The check valve assembly 135 allows liquid to flow in a one-way direction, to prevent backflow of the liquid, thereby avoiding the cleaning brush from dripping when hanging upside down. A piston 136 is arranged inside the push rod end 132, a rod portion of the piston 136 is connected with the button 126. When the user presses the button 126, the button 126 drive the plug 127 to reciprocate within the second chamber 1301. As the piston 136 moves into the second chamber 1301, the air pressure within the second chamber 1301 decreases, generating a negative pressure, and the negative pressure enable the check valve assembly 135 to lift in the inlet end 133, thereby opening the inlet end 133 and allowing liquid to be sucked into the second chamber 1301. As the piston 136 resets, the air pressure within the second chamber 1301 increases, the check valve assembly 135 at the outlet end 134 lifts, opening the outlet end 134 and forcing the liquid out through the outlet end 134, thereby enabling the liquid to be sprayed out through the outlet port 1233.

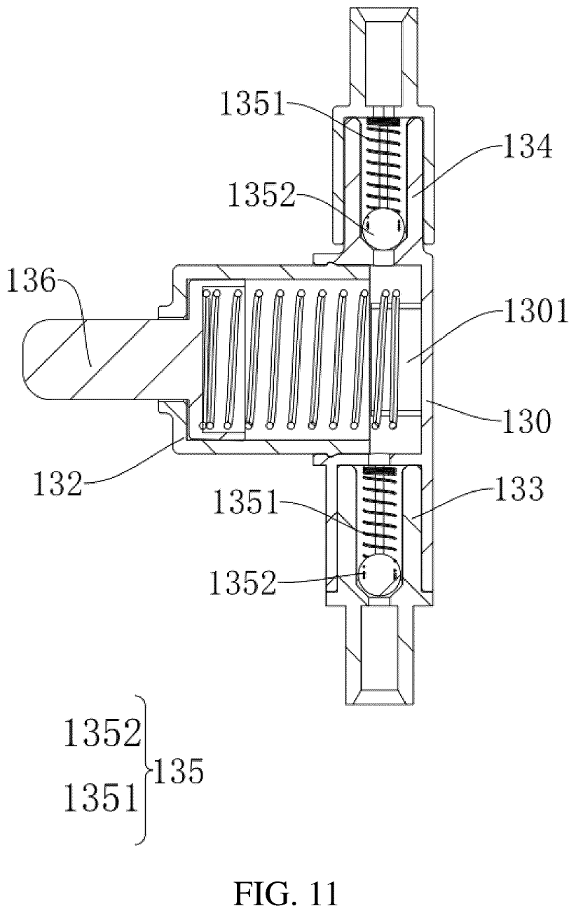

In an embodiment of the present disclosure, as shown in FIG. 11, the check valve assembly 135 includes a resilient member 1351 (such as a spring, elastic sheet, silicone or materials with elasticity) and a barrier member 1352 (such as a steel ball, valve core, or diaphragm) that abuts against the resilient member 1351. At least a part of the inlet end 133 and a part of the outlet end 134 is configured as a narrow channel, and the barrier member 1352 is able to block the narrow channel. The resilient member 1351 provides an elastic force, enabling the barrier member 1352 to open or close the inlet end 133 and the outlet end 134 according to different pressure. In the absence of fluid or negative pressure, the elastic force of the resilient member 1351 pushes the barrier member 1352 moving toward the narrow channel of the inlet end 133 or the outlet end 134, thereby avoiding backflow of the liquid. When negative pressure is generated in the second chamber 1301, the barrier member 1352 overcomes the elastic force of the resilient member 1351, the negative pressure enables the barrier member 1352 to move and open the channel, thereby allowing the liquid to pass through.

In an embodiment of the present disclosure, as shown in FIG. 7, the pump 13 is arranged inside a third chamber 1201 of the brush head member 12, thereby preserving space inside the bottle body 11, and allowing a larger capacity. In this way, the liquid can be delivered near the bristles 1232 more efficiently, reducing pressure loss. Alternatively, the pump 13 may be disposed inside the bottle body 11, which makes the center of gravity of the cleaning brush closer to the bottle body 11, thereby increasing stability during use. Also, the bottle body 11 can provide protection for the pump 13, reducing the risk of damage from external impacts.

In an embodiment of the present disclosure, as shown in FIG. 12, the brush head member 12 is detachably connected with the second end 112 of the bottle body 11, the second end 112 of the bottle body 11 has an opening, which served as a bottle opening, allowing users to remove the brush head member 12 and replenish the liquid inside the bottle body 11.

In an embodiment of the present disclosure, as shown in FIG. 12, the plug 127 is detachably and sealingly connected with the second end 112 of the bottle body 11, ensuring a tight seal to prevent liquid leakage when the bottle body 11 is tilted or inverted. In some embodiments, the plug 127 is threaded connected with the bottle opening, and a sealing ring is arranged between the plug 127 and the bottle opening to ensure a tight seal. As a result, the brush head member 12 can be detached or installed to the bottle body 11 quickly. The plug 127 has a connecting channel 1271, which communicates the conduit inside the bottle body 11 and the inlet end 133 of the pump 13, allowing liquid to flow from the bottle body 11 to the pump 13.

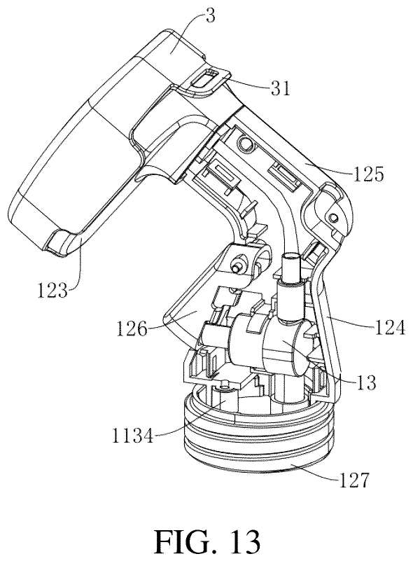

In an embodiment of the present disclosure, as shown in FIG. 4 and FIG. 13, a one-way inlet valve 1134 is arranged on the bottle body 11, preferably on an end face 1111 of the first end 111 of the bottle body 11. When the cleaning brush is in use, the water pump 13 generates negative pressure, a one-way inlet valve 1134 ensures that air flows into the bottle body 11 in a single direction, such that the air pressure inside the bottle body 11 is balanced. In this way, the pump 13 can work efficiently during liquid extraction, preventing fluid delivery issues caused by instability of air pressure. Alternatively, the one-way air inlet valve 1134 may be arranged on the plug 127, which also enables an air communication. Furthermore, as the plug 127 is detachably connected with the bottle opening, the maintenance or replacement of the one-way inlet valve 1134 becomes more convenient.

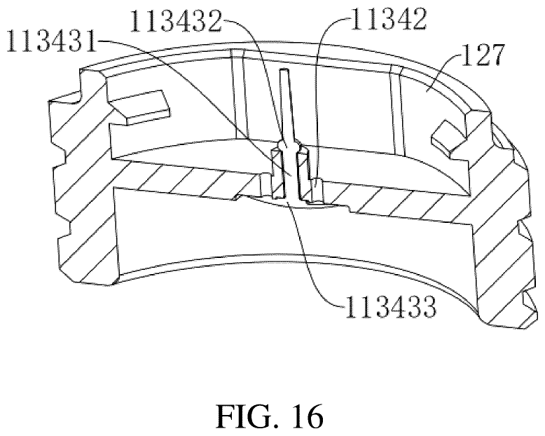

In an embodiment of the present disclosure, as shown in FIG. 15 and FIG. 16, the one-way air inlet valve 1134 includes a flexible valve plug 11343, a valve plug passage 11341, and at least one air vent 11342. The valve plug passage 11341 is defined in the plug 127, and the valve plug 11343 is mounted within the valve plug passage 11341. The at least one air vent 11342 is defined on the plug body 127 and is positioned adjacent to the valve plug passage 11341. An interior and an exterior of the bottle body 11 are in communication with each other through the at least one air vent 11342. The valve plug 11343 includes a retaining portion 113432, a rod portion 113431, and a dome-shaped sealing portion 113433. The retaining portion 113432, the rod portion 113431, and the sealing portion 113433 are sequentially connected with each other. The rod portion 113431 is positioned in the plug passage 11341. At least a part of the retaining portion 113432 laterally extends from the rod portion 113431 and is retained at a side of the valve plug passage 11341 away from the bottle body 11. The sealing portion 113433 is disposed at a side of the valve plug passage 11341 proximate to the bottle body 11. When the air pressure inside the bottle body 11 is lower than the air pressure outside the bottle body 11, a pressure difference causes the flexible valve plug 11343 to deform, such that the sealing portion 113433 moves downwardly to open the air vent 11342, allowing air to enter the bottle body 11 via the air vent 11342. When the pressure difference between the inside and outside of the bottle body 11 decreases or is eliminated, the flexible valve plug 11343 elastically returns to its original shape, and the sealing portion 113433 moves upwardly to re-seal the air vent 11342.

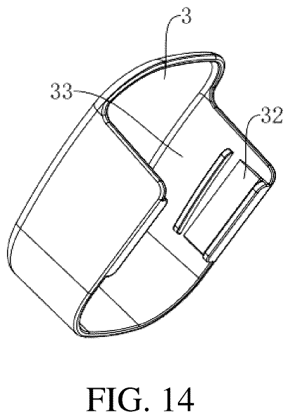

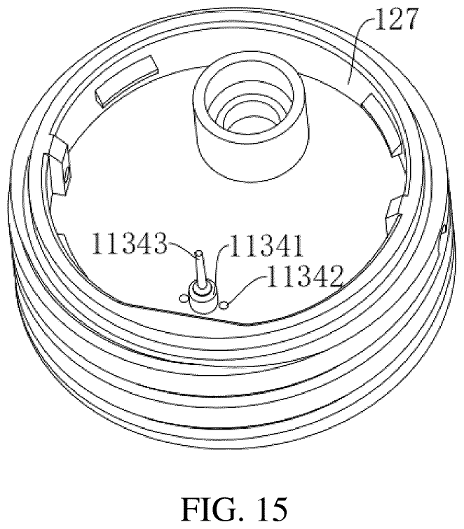

In an embodiment of the present disclosure, as shown in FIG. 2, the protective cover 3 is detachably connected to the brush head member 12, which facilitates the user in removing the protective cover 3 during use. After use, if the bristles 1232 become dirty, the user can mount the protective cover 3 over the bristles 1232, to prevent the bristles 1232 from soiling the golf bag or the user's clothing, thereby allowing the bristles 1232 to stay clean. In addition, the protective cover 3 provides protection for the bristles 1232 while the cleaning brush is not in use. In an embodiment, the protective cover 3 includes a protrusion 31, by which the user can pull to remove the protective cover 3 with ease. In another embodiment, as shown in FIG. 14, the protective cover 3 includes an access opening 33, and a sliding groove 32 is defined in an inner wall of the protective cover 3. The user can assemble or remove the protective cover 3 by sliding the protective cover 3 through the access opening 33 along the sliding groove 32.

In an embodiment of the present disclosure, as shown in FIG. 10, a cord through hole is configured to thread a cord or a strap, allowing the cleaning brush to be hung on a wall or other fixed place for space-saving, it also makes it more convenient for users to carry the cleaning brush.

It should be clarified that the technical features described above may be combined in various ways to form embodiments not explicitly listed above, which are considered part of the scope of this application. Moreover, skilled artisans may make improvements or alterations based on the description, and all such improvements and alterations should be within the scope of the claims attached to this application.

1. A cleaning brush, comprising:
a body portion of the cleaning brush;
a hook member, comprising a hook body and a latch, wherein the hook body is rigidly connected with the body portion of the cleaning brush, and the hook body defines an opening, the latch is movably connected with the hook body to open or close the opening:
wherein, the body portion of the cleaning brush comprises a brush head member and a bottle body; the bottle body has a first end and a second end opposite to the first end; the bottle body defines a first chamber and a bottle body opening communicated to the first chamber; the bottle body opening is formed at the second end of the bottle body, liquid for cleaning is capable of being added to the first chamber through the bottle body opening; the second end of the bottle body is detachably connected to the brush head member; an end face that seals the first chamber is formed at the first end of the bottle body, the hook body is rigidly connected to the end face.

2. The cleaning brush according to claim 1, wherein the hook body and the body portion of the cleaning brush are configured as an integral and one-piece structure.

3. The cleaning brush according to claim 1, wherein the hook body is detachably connected with the body portion of the cleaning brush.

4. The cleaning brush according to claim 1, wherein the hook body comprises an annular portion, the annular portion comprises a first open end and a second open end;
wherein the latch comprises a connecting end and a movable end, the connecting end is pivotally connected with the first open end, and the movable end is selectively in contact with or separated from the second open end.

5. The cleaning brush according to claim 1, wherein the body portion of the cleaning brush comprises a first connecting member, the hook body comprises a second connecting member;
one of the first connecting member and the second connecting member is a slot, the other one of the first connecting member and the second connecting member is a protrusion, the protrusion is received in and snapped with the slot.

6. The cleaning brush according to claim 1, wherein
an outlet port is defined in the brush head member, and the brush head member is arranged with bristles;
the body portion of the cleaning brush further comprises a pump, the pump comprising an inlet end and an outlet end, wherein the inlet end communicates with the first chamber, the outlet end communicates with the outlet port; the liquid is capable of being sprayed out through the outlet port.

7. The cleaning brush according to claim 6, wherein the brush head member comprises:
a brush head housing, comprising a handle portion and a brush head portion, wherein the handle portion and the brush head portion are connected with each other in sequence, an end of the handle portion away from the brush head portion is connected with the second end of the bottle body, the brush head portion has an inclined surface, an acute angle is formed between the inclined surface and a longitudinal direction of the bottle body, and the outlet port and the bristles are disposed on the inclined surface.

8. The cleaning brush according to claim 7, wherein the handle portion comprises:
a grip section and a connecting section, wherein the grip section substantially extends along the longitudinal direction of the bottle body, an angle is formed between the connecting section and the grip section, and a press part is formed at a joint between the connecting section and the grip section;
a button, connected with the pump, wherein the button is positioned on a side of the grip section opposite to the press part.

9. The cleaning brush according to claim 8, wherein the grip section comprises a first side surface, the first side surface is inclined towards the press part, and the button is disposed on the first side surface.

10. The cleaning brush according to claim 8, wherein the handle portion comprises a rear surface, at least a portion of the rear surface is truncated inwardly to form a flat surface.

11. The cleaning brush according to claim 8 wherein the handle portion comprises a front surface and a rear surface, at least a portion of the front surface and at least a portion of the rear surface are both truncated inwardly to form flat surfaces.

12. The cleaning brush according to claim 9, wherein the grip section comprises a second side surface, the second side surface is opposite to the first side surface, and a concave surface is formed at a joint between the second side surface and the press part.

13. The cleaning brush according to claim 6, wherein the pump comprises:
a pump housing, wherein a second chamber is defined inside the pump housing;
a push rod end, wherein the push rod end, the inlet end, and the outlet end are in communication with the second chamber, a check valve assembly is received in each of the inlet end and the outlet end, and the push rod end is provided with a piston, the piston compresses gas within the second chamber to generate a negative pressure to pump and transport the liquid.

14. The cleaning brush according to claim 13, wherein the check valve assembly comprises a resilient member and a barrier member, the barrier member abuts against the resilient member, the barrier member blocks at least a portion of the inlet end or the outlet end, and the barrier member is movable along the inlet end or the outlet end, the resilient member is configured to resiliently expand and contract to drive the barrier member to block the inlet end or the outlet end, or to move and open the inlet end or the outlet end.

15. The cleaning brush according to claim 13, wherein the brush head member defines a third chamber, and the pump is arranged within the third chamber.

16. The cleaning brush according to claim 15, wherein the second end of the bottle body has an opening, and the brush head member is detachably connected with the second end of the bottle body.

17. The cleaning brush according to claim 16, wherein the brush head member further comprises a plug, the plug is detachably and sealingly connected with the second end of the bottle body, and a connecting channel is defined in the plug to communicate with the inlet end.

18. The cleaning brush according to claim 6, further comprising a one-way inlet valve, wherein the one-way inlet valve is configured to drive air to flow unidirectionally from the outside of the bottle body to the inside of the bottle body.

19. The cleaning brush according to claim 6, further comprising a protective cover, wherein the protective cover is detachably mounted over the bristles.

20. The cleaning brush according to claim 8, wherein a cord through hole is defined in the press part.
